(19) United States
(12) Patent Application Publication
(10) Pub. No.: US 2024/0419658 A1
(43) Pub. Date: Dec. 19, 2024

(54) PROFILE-BASED ARTIFICIAL INTELLIGENCE SYSTEM

(71) Applicant: Palantir Technologies Inc., Denver, CO (US)

(72) Inventors: Mohamed Zaki Trache, London (GB); Martin Copes, London (GB); Christopher Jeganathan, London (GB); Frauke Hein, London (GB); Arttu Voutilainen, Zug (CH); Adam Balogh, London (GB); Joseph Hashim, London (GB)

(21) Appl. No.: 18/675,672

(22) Filed: May 28, 2024

Related U.S. Application Data
(60) Provisional application No. 63/508,201, filed on Jun. 14, 2023.
(60) Provisional application No. 63/510,588, filed on Jun. 27, 2023.

(51) Int. Cl. G06F 16/242; H04L 67/306

(52) U.S. Cl. CPC G06F 16/243; H04L 67/306

(57) ABSTRACT

An artificial intelligence system can be used to respond to natural language inputs (e.g., user submitted inputs) where the response involves a data processing workflow involving language models. The artificial intelligence system can use “profiles” associated with a user, role, cohort, and/or organization to bring additional operational context into user interactions within the artificial intelligence system.

### BACKGROUND

Some computer systems limit access to electronic data assets by requiring authentication credentials, such as a username and password. Some computer systems also impose authorization credentials restrictions that specify which user or groups of users can read, write, or modify an electronic data asset. However, these computer systems can be insufficient for protecting and auditing access to electronic data assets. Furthermore, the use of authentication credentials and authorization restrictions, without more, can be inefficient and take large amounts of time, data, and memory to administer, especially when making large scale changes. Authentication credentials and authorization restrictions may also be insufficient for protecting private or confidential electronic data assets.

### SUMMARY

The above problems may be exacerbated when a computer system involves computer-based models (generally referred to herein as “models”), such as deep neural network models and/or large language models. For example, a model may have access to electronic data assets that a user may not have access to, causing the model to inadvertently reveal private or confidential electronic data assets. On the other hand, a model must have access to the particular set of tools and assets necessary to accomplish its assigned tasks.

Moreover, sophisticated computer-based models may perform better when provided with a detailed prompt. For example, large language models can consume long prompts with detailed instructions. However, in many cases, it may be impractical and inefficient for a user querying such a model to provide such detailed instructions to the model (e.g., due to time constraints or lack of knowledge).

As discussed herein, an Artificial Intelligence System (“AIS”) is configured to activate large language models (LLMs) and/or other artificial intelligence processes based on natural language input provided by a user via an interactive user interface (and/or other input device). An AIS may select and execute appropriate data services, e.g., via plugins, which may be configured to communicate with proprietary and/or publicly available data sources, as well as LLMs and/or other artificial intelligence processes. This disclosure describes examples configurations and operations of AISs, including a profile-based AIS. Other AISs may include fewer, additional, and/or different components or functionality.

Generally described, the present disclosure relates to a profile-based AIS for querying language models (generally referred to herein as “the system”). The present disclosure further includes various processes, functionality, and interactive graphical user interfaces related to the system. According to various implementations, the system (and related processes, functionality, and interactive graphical user interfaces) can advantageously provide for the generation of detailed prompts to a language model without requiring a user to write out voluminous instructions, while simultaneously ensuring protection of private or confidential electronic data assets. Various implementations of the present disclosure can advantageously overcome various of the technical challenges mentioned above, among other technical challenges. For example, the system may receive a simple user input and automatically generate a detailed prompt for the language model based on a “profile” associated with a particular user, role, cohort, use case, organization, and/or context. The system may also control access to certain electronic data assets with respect to both the user and the computer-based model.

Various embodiments of the present disclosure provide improvements to various technologies and technological fields. For example, as described above, the use of profiles may advantageously improve the performance and accuracy of an artificial intelligence system by formulating detailed, efficient, and tailored prompts to a language model. Other technical benefits provided by various embodiments of the present disclosure include, for example, transparency by way of visualizations of a language model's processing (e.g., tools utilized by the language model), flexibility in configuring profiles and access to language models based on organizational needs, and accuracy improvements by fine-tuning the artificial intelligence system based on post hoc feedback.

Additionally, various embodiments of the present disclosure are inextricably tied to computer technology. In particular, various embodiments rely on detection of user inputs via graphical user interfaces, calculation of updates to displayed electronic data based on those user inputs, automatic processing of related electronic data, application of language models and/or other artificial intelligence, and presentation of the updates to displayed information via interactive graphical user interfaces. Such features and others (e.g., processing and analysis of large amounts of electronic data) are intimately tied to, and enabled by, computer technology, and would not exist except for computer technology. For example, the interactions with displayed data described below in reference to various embodiments cannot reasonably be performed by humans alone, without the computer technology upon which they are implemented. Further, the implementation of the various embodiments of the present disclosure via computer technology enables many of the advantages described herein, including more efficient interaction with, and presentation of, various types of electronic data.

Various combinations of the above and below recited features, embodiments, and aspects are also disclosed and contemplated by the present disclosure. Additional embodiments of the disclosure are described below in reference to the appended claims, which may serve as an additional summary of the disclosure.

### BRIEF DESCRIPTION OF THE DRAWINGS

The following drawings and the associated descriptions are provided to illustrate embodiments of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1A is a block diagram illustrating an example artificial intelligence system in communication with various devices to orchestrate fulfillment of a user prompt.

FIG. 1B is a block diagram illustrating example data flows of an example artificial intelligence system.

FIG. 2 is a block diagram illustrating an example profile data object.

FIG. 3 is a flow diagram illustrating an example method according to various embodiments.

FIG. 4 illustrates an example user interface showing the contents of an example profile.

FIG. 5 illustrates another example user interface showing the contents of an example profile.

FIG. 6 illustrates an example user interface showing an example excerpt from an example profile template.

FIG. 7 illustrates an example user interface for configuring or setting rules associated with an example profile template.

FIG. 8 illustrates an example user interface for starting an AI system session.

FIG. 9 illustrates an example user interface according to various embodiments.

### DETAILED DESCRIPTION

Although certain embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### Terms

To facilitate an understanding of the systems and methods discussed herein, several terms are described below. These terms, as well as other terms used herein, should be construed to include the provided descriptions, the ordinary and customary meanings of the terms, and/or any other implied meaning for the respective terms, wherein such construction is consistent with context of the term. Thus, the descriptions below do not limit the meaning of these terms, but only provide example descriptions.

Model: any computer-based models of any type and of any level of complexity, such as any type of sequential, functional, or concurrent model. Models can further include various types of computational models, such as, for example, artificial neural networks (“NN”), language models (e.g., large language models (“LLMs”)), artificial intelligence (“AI”) models, machine learning (“ML”) models, multimodal models (e.g., models or combinations of models that can accept inputs of multiple modalities, such as images and text), and/or the like.

Language Model: any algorithm, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language responses based on the text on which the model is trained. A language model may include an n-gram, exponential, positional, neural network, and/or other type of model.

Large Language Model (“LLM”): any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise a NN trained using self-supervised learning. An LLM may be of any type, including a Question Answer (“QA”) LLM that may be optimized for generating answers from a context, a multimodel LLM/model, and/or the like. An LLM (and/or other models of the present disclosure), may include, for example, attention-based and/or transformer architecture or functionality LLMs can be extremely useful for natural language processing, including receiving natural language prompts and providing natural language responses based on the text on which the model is trained. LLMs may not be data security- or data permissions-aware, because they generally do not retain permissions information associated with the text upon which they are trained. Thus, responses provided by LLMs are typically not limited to any particular permissions-based portion of the model.

While certain aspects and implementations are discussed herein with reference to use of a language model, LLM, and/or AI, those aspects and implementations may be performed by any other language model, LLM, AI model, generative AI model, generative model, ML model, NN, multimodel model, and/or other algorithmic processes. Similarly, while certain aspects and implementations are discussed herein with reference to use of a ML model, those aspects and implementations may be performed by any other AI model, generative AI model, generative model, NN, multimodel model, and/or other algorithmic processes.

In various implementations, the LLMs and/or other models (including ML models) of the present disclosure may be locally hosted, cloud managed, accessed via one or more Application Programming Interfaces (“APIs”), and/or any combination of the foregoing and/or the like. Additionally, in various implementations, the LLMs and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLAMA (Large Language Model Meta AI), and BigScience Large Open-science Open-access Multilingual Language Model (BLOOM).

Data Processing Service (or “Service” or “Plug-in”): receives and responds to requests for data and/or data processing. A Plug-in may be accessible via an API that is exposed to one or more an Artificial Intelligence System (and/or other remote systems) and allows data processing requests to be received via API calls from those systems (e.g., an AIS). A few examples of services or plug-ins include a table search service, a filter service, an object search service, a text search service, or any other appropriate search service, indexing services, services for formatting text or visual graphics, services for generating, creating, embedding and/or managing interactive objects in a graphical user interface, services for caching data, services for writing to databases, an ontology traversing service (e.g., for traversing an ontology or performing search-arounds in the ontology to surface linked objects or other data items) or any other data retrieval, processing, and/or analysis function.

Natural Language Prompt: a term, phrase, question, and/or statement written in a human language (e.g., English, Chinese, Spanish, etc.) that serves as a starting point for a language model and/or other language processing. A natural language prompt may be generated based on user input and/or automatically by a language model, for example.

User Input (or “Natural Language Input”): a term, phrase, question, and/or statement written in a human language (e.g., English, Chinese, Spanish, etc.) that is provided by a user and indicates a request for data, such as data accessed and/or processed by one or more services.

Context: any information associated with a user, user session, or some other characteristic, which may be stored and/or managed by a context module. Context may include all or part of a conversation history from one or more sessions with the user (e.g., a sequence of user prompts and orchestrator selector responses or results, and/or user selections (e.g., via a point and click interface or other graphical user interface). Thus, context may include one or more of: previous analyses performed by the user, previous prompts provided by the user, previous conversation of the user with the language model, schema of data being analyzed, a role of the user, a context of the data processing system (e.g., the field), and/or other contextual information.

A context module may provide all or only a relevant portion of context to a selection module for use in selecting one or more plug-ins and/or service orchestrators (e.g., configured to generate requests to plug-ins) for use in generating a properly formatted service request. In some embodiments, context may include identification of services and parameters of prior operations, but not underlying data that was accessed or retrieved by the service (e.g., use of graph visualization service and graph parameters without indicating the data illustrated in the graph). In some embodiments, context may include some or all of the underlying data accessed or retrieved by the service.

Ontology: stored information that provides a data model for storage of data in one or more databases and/or other data stores. For example, the stored data may include definitions for data object types and respective associated property types. An ontology may also include respective link types/definitions associated with data object types, which may include indications of how data object types may be related to one another. An ontology may also include respective actions associated with data object types or data object instances. The actions may include defined changes to values of properties based on various inputs. An ontology may also include respective functions, or indications of associated functions, associated with data object types, which functions may be executed when a data object of the associated type is accessed. An ontology may constitute a way to represent things in the world. An ontology may be used by an organization to model a view on what objects exist in the world, what their properties are, and how they are related to each other. An ontology may be user-defined, computer-defined, or some combination of the two. An ontology may include hierarchical relationships among data object types.

Data Object (or “Object”): a data container for information representing a specific thing in the world that has a number of definable properties. For example, a data object can represent an entity such as a person, a place, an organization, a market instrument, or other noun. A data object can represent an event that happens at a point in time or for a duration. A data object can represent a document or other unstructured data source such as an e-mail message, a news report, or a written paper or article. Each data object may be associated with a unique identifier that uniquely identifies the data object. The object's attributes (also referred to as “contents”) may be represented in one or more properties. Attributes may include, for example, metadata about an object, such as a geographic location associated with the item, a value associated with the item, a probability associated with the item, an event associated with the item, and so forth.

### Example System

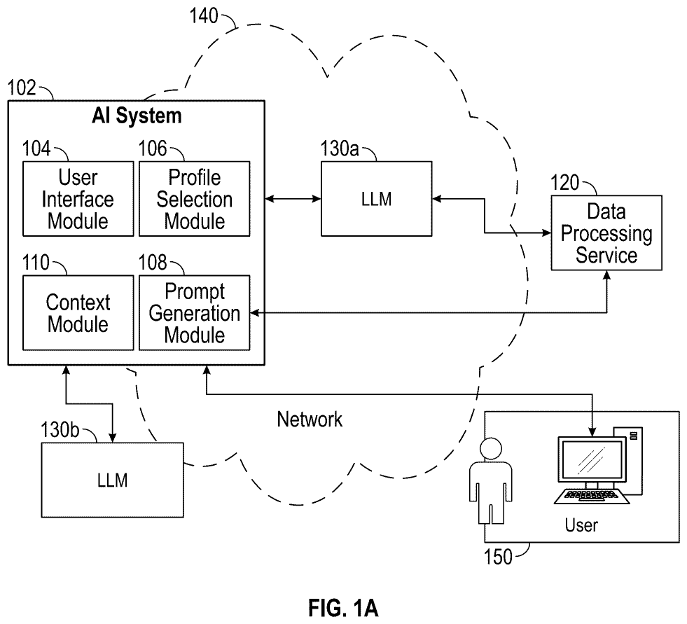

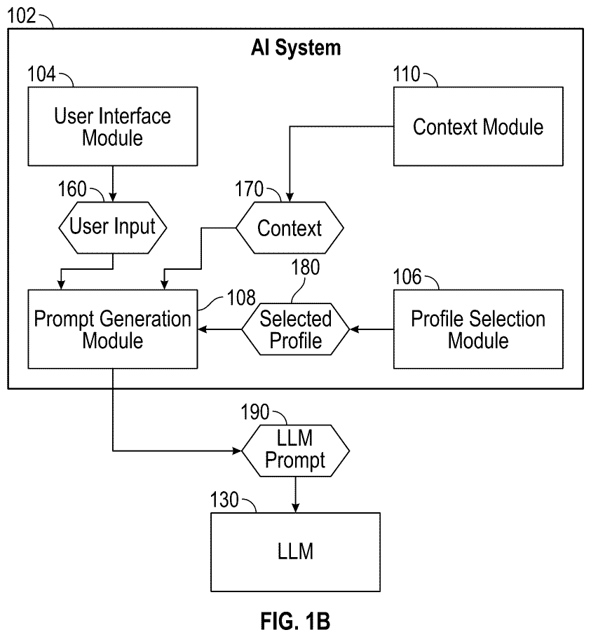

FIG. 1A is a block diagram illustrating an example Artificial Intelligence System (or “AIS”) 102 in communication with various devices to respond to a user prompt. In the example of FIG. 1A, the Artificial Intelligence System 102 comprises various modules, including a User Interface Module 104, a Profile Selection Module 106, a Prompt Generation Module 108, and a Context Module 110. In other embodiments, the AIS 102 may include fewer or additional components.

In the example of FIG. 1A, the various devices are in communication via a network 140, which may include any combination of networks, such as one or more local area network (LAN), personal area network (PAN), wide area network (WAN), the Internet, and/or any other communication network. In some embodiments, modules of the illustrated components, such as User Interface Module 104, Profile Selection Module 106, Prompt Generation Module 108, and Context Module 110 of the Artificial Intelligence System 102, may communicate via an internal bus and/or via the network 140.

A user interface module 104 is configured to generate user interface data that may be rendered on a user device 150, such as to receive an initial user input, as well as later user input that may be used to initiate further data processing. In some embodiments, the functionality discussed with reference to the user interface module 104, and/or any other user interface functionality discussed herein, may be performed by a device or service outside of the Artificial Intelligence System 102 and/or the user interface module 104 may be outside the Artificial Intelligence System 102. Example user interfaces are described in greater detail below.

A profile selection module 106 is configured to maintain, select, and/or provide profiles that are usable in interactions with other data sources, such as an LLM or plug-in. For example, the profile selection module 106 may maintain a list of profiles that are associated with a specific user, user role, organization, cohort, and/or context. For example, the list of profiles may include separate profiles for user roles such as Supply Chain Manager, Medical Diagnostician, Marketing Strategist, Legal Analyst, Human Resource Manager, Manufacturing Engineer, Urban Planner, Agricultural Scientist, Life Sciences Analyst, Credit Risk Analyst, etc. In some embodiments, the profile selection module 106 may be configured to select an appropriate profile (e.g., based on a specific user or other contextual information), while in other embodiments, a profile may be selected through other means (e.g., by a user through the user interface module 104).

A context module 110 is configured to maintain, select, and/or provide some or all relevant context associated with a user input, user session, multiple sessions of the user, and/or other context. The context module 110 may store context for various groups of users, e.g., user inputs from multiple users. The Artificial Intelligence System 102 and/or other components of the system may make use of context in fulfilling their functions. Context may include, for example, all or part of a conversation history from one or more sessions with the user (e.g., a sequence of user inputs and responses or results), user selections (e.g., via a point and click interface or other graphical user interface), data processing services 120 implemented during the session, user-selected objects and any corresponding properties for those objects, any linked objects as defined by a relevant ontology, and the like. As one example, if a most recent result returned to a user included a filtered set of “flight” objects, and a user types “send an email listing the flights to my manager,” the AIS 102 may make use of the context of the filtered set of aircraft objects, as provided by the context module, and include a list of those objects in an email.

In some embodiments, the context module 110 and profile selection module 106 may be implemented as a single module configured to perform the functions of both the context module 110 and profile selection module 106. In some embodiments, the user interface module 104 may suggest certain actions to the user (e.g., any actions described herein, or any other related actions) based on context provided by context module 110 (e.g., email the account manager of the account that is being displayed).

A prompt generation module 108 is configured to generate a prompt to a language model, such as LLM 130a. As described in further detail below, the prompt generation module 108 may generate such a prompt based on data provided by the user interface module 104 (e.g., a user input), the profile selection module 106 (e.g., a selected profile), and/or the context module 110 (e.g., additional contextual information).

In the example of FIG. 1A, a user 150 (which generally refers to a computing device of any type that may be operated by a human user) may provide a prompt to the Artificial Intelligence System 102 indicating a natural language request for some data analysis to be performed. In some embodiments, the user may select one or more object types to limit processing by the AIS 102 to only those selected object types (which may increase speed and relevance of responses provided by the system), while in other embodiments the user may not provide any information except an initial input.

The Artificial Intelligence System 102 may include and/or have access to one or more large language model (LLM) or other language model, and the LLM may be fine-tuned or trained on appropriate training data (e.g., annotated data showing correct or incorrect pairings of sample natural language queries and responses). After receiving a user input, the Artificial Intelligence System 102 may generate and provide a prompt to a LLM 130a, which may include one or more large language models trained to fulfill a modeling objective, such as task completion, text generation, summarization, etc.

The LLM 130a and various modules of the Artificial Intelligence System, such as Prompt Generation Model 108, may also communicate with one or more Data Processing Services 120 in the course of fulfilling a user input. The data processing services 120 may include any quantity of services (or “plug-ins”) and any available type of service. For example, the services 120 may include one or more search services (e.g., a table search service, an object search service, a text search service, or any other appropriate search service), indexing services, services for formatting text or visual graphics, services for generating, creating, embedding and/or managing interactive objects in a graphical user interface, services for caching data, services for writing to databases, an ontology traversing service (e.g., for traversing an ontology or performing search-arounds in the ontology to surface linked objects or other data items) or any other services. For example, the LLM 130a may request (either directly or through AIS 102) for data processing services 120 to perform a specific process. In some implementations, the data processing services 120 may be a part of the AIS 102 (e.g., as part of a data processing services module of AIS 102).

The Artificial Intelligence System 102 may then receive an output from an LLM 130a and provide a result to a user. In some embodiments, the Artificial Intelligence System 102 may provide the entire output from the LLM 130a as a result to the user, while in other embodiments, the Artificial Intelligence System 102 may modify the output before providing a result to a user. The result that is provided to a user (in response to a user input) may include text, images, maps, interactive graphical user interfaces, datasets, database items, audio, actions, or other types or formats of information. In some embodiments, an action included in the results may only be executed subject to a further confirmation from a user, thus providing important oversight of the Artificial Intelligence System 102. Actions may include writing to datasets (e.g., adding or updating rows of a table, editing or updating an object type, updating parameter values for an object instance, generating a new object instance), implementing integrated applications (e.g., an email or SMS application), communicating with external application programming interfaces (APIs), and/or any other functions that communicate with other external or internal components. For example, results provided to a user (e.g., via the User Interface Module 104) may include a message indicating that the request is unsupported, or a message indicating that more information or clarification is needed to process the request.

As shown, the AIS 102 may be capable of interfacing with multiple LLMs. This allows for experimentation and adaptation to different models based on specific use cases or requirements, providing versatility and scalability to the system. In some implementations, the AIS 102 may interface with a second LLM 130b in order to, for example, generate an input to a data processing service 120, or to generate some or all of a natural language prompt (e.g., generate a prompt for the first LLM 130a).

FIG. 1B is a block diagram illustrating example data flows of an example artificial intelligence system. As described above, the Artificial Intelligence System 102 comprises various modules, including User Interface Module 104, Profile Selection Module 106, Prompt Generation Module 108, and Context Module 110. The indicated data flows of FIG. 1B are exemplary of only certain processes performed by an Artificial Intelligence System 102 and is not meant to include all possible blocks and participants.

As described above, user interface module 104, profile selection module 106, and context module 110 may provide various data to the prompt generation module 108. In the example of FIG. 1B, the user interface module 104 may provide a user input 160 to the prompt generation module 108. For example, the user input 160 may comprise a natural language request for some data analysis to be performed, such as based on a set of object types. The context module 110 may provide context 170 to the prompt generation module 108. For example, the context 170 may comprise all or part of a conversation history from one or more sessions of prior user interaction with the Artificial Intelligence system 102. The profile selection module 106 may provide a selected profile 180 to the prompt generation module 108, such as based on a role or identity of the user. In some embodiments, the profile selection module 106 selects a profile at the start of a user session and uses the same profile throughout the user session (e.g., where a user session includes multiple sequential user inputs and responses from an LLM and/or other plug-ins). Further examples of profiles and content contained within profiles are provided in greater detail below.

After receiving the user input 160, the context 170, and the selected profile 180, the prompt generation module 108 may generate an LLM prompt 190 based at least partly on the user input 160, the context 170, and the selected profile 180. Thus, the prompt 190 may be better focused on a particular task (e.g., associated with a role of the user) so that the LLM 130a provides more relevant and specific information in its response to the prompt 190. Further examples of LLM prompts and the generation of LLM prompts will be described in greater detail below. The prompt generation module 108 may then provide the generated LLM prompt 190 to the LLM 130a.

In the examples of FIGS. 1A and 1B, the Artificial Intelligence System 102 includes multiple modules that perform various functions and may communicate with one another and/or outside devices. Depending on the embodiment, the functionality of the various modules may be combined into fewer modules or separated into additional modules. Additionally, in some embodiments an Artificial Intelligence System 102 may not include all of the modules and/or functionality discussed herein with reference to particular modules.

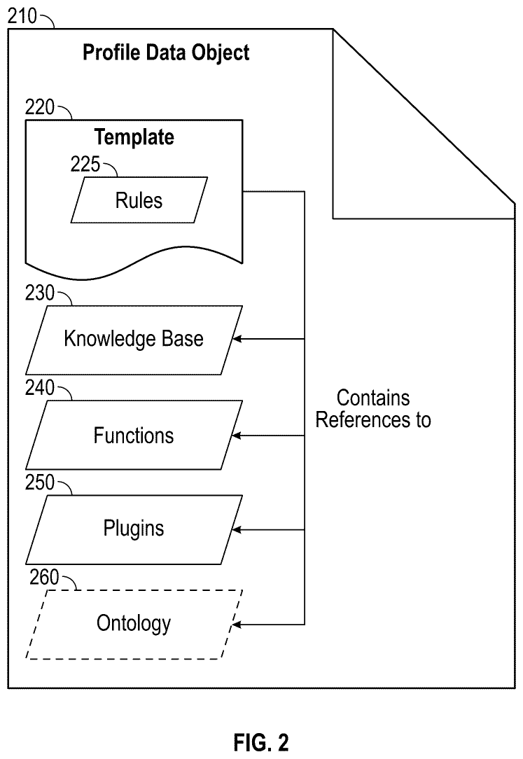

FIG. 2 is a block diagram illustrating an example content of a profile, such as may be stored in a profile data object 210 (or “profile”). As described above, a profile 210 may be associated with a particular user, user role, and/or context. A profile 210 may comprise several distinct elements, such as indications of a knowledge base 230, functions 240, template(s) 220, plugins 250, and/or other parameters that may be used in generating a prompt to an LLM. In some implementations, a profile 210 may further indicate an ontology 260. In some implementations, a profile 210 may be associated with one or more language models. For example, a language model (e.g., GPT4) associated with a selected profile may be automatically selected (as the LLM 130a) for receiving prompts from the AIS that are generated during that user session. Each of these elements are described in further detail below.

The example profile 210 indicates one or more knowledge bases 230. The knowledge base 230 may comprise indications of a searchable corpus or repository of information such as may be stored in any type of data structure, e.g., a database, table, text document, etc. The knowledge base 230 may represent the universe of information that may be searched or referenced by the LLM and/or plug-ins that are involvement in generating a response to a user prompt. For example, the universe of information indicated may be limited to certain databases, documents, or other data structures that are relevant to fulfillment of tasks associated with the particular profile, and for which the user has permission to access. In some implementations, the knowledge base 230 may comprise pointers, or some other link or indication, to raw documents and/or data stored in another location. For example, the knowledge base 230 may contain a list of document IDs referring to documents stored in a database or a list of locations/addresses where information is stored.

The knowledge base 230 may include indications of external information (such as publicly-available or privately-accessible documents), internal information (such as organizational data and assets), or both. For example, a knowledge base 230 indicated in a profile 210 associated with the role of a “life science analyst” may comprise indications of articles published in medical or scientific journals, while a knowledge base 230 indicated in a profile 210 associated with the role of a credit risk analyst may comprise indications of credit report public records.

A profile 210 may further indicate one or more functions 240 (or formulas) that may be used to calculate and derive properties. For example, a profile 210 associated with the role of a life science analyst may comprise indications of chemical or biological formulas, while a profile 210 associated with the role of a credit risk analyst may comprise functions for calculating or approximating credit risk. Thus, calculations that are performed by the LLM may rely on functions 240 provided in a prompt and are known to be accurate for the particular context, rather than attempting to identify functions to perform calculations in a general corpus of documents.

A profile 210 may further indicate one or more plugins 250. Plugins 250 may be software tools that may be utilized directly by the AIS and/or by a language model with which the system interacts. The plugins 250 may include internal software tools developed by an organization or software tools obtained from a third-party. For example, a plugin 250 indicated in a profile 210 may be configured to access a knowledge base 230 that is also identified in the profile 210. Thus, a language model may access the knowledge base 230 through execution of an appropriate plugin 250, e.g., a plugin that is configured for API access to the knowledge base 230. For example, a profile 210 associated with the role of a credit risk analyst may indicate tools for visualizing large amounts of aggregated credit risk data.

In some implementations, a profile 210 may indicate an ontology 260. For example, a profile 210 may include indications of a semantic knowledge graph of organizational data objects, which may be traversed or otherwise accessed by a language model.

A profile 210 may further comprise one or more templates 220. The templates 220 may represent or include rules 225 of business logic that may be included in and/or may otherwise be used to form a prompt that is provided to a language model. For example, a profile 210 associated with the role of a credit risk analyst may include a natural language description of an overall goal and expected output from the LLM, such as an instruction to flag a certain file upon a determination that the risk level exceeds a certain threshold. In some implementations, the rules may be stored or defined in free-text. In some implementations, the rules 225 can be associated with particular data objects. In some implementations, a template 220 may include placeholders which can be later modified or replaced based on the operational context of a particular user interaction, such as based on context, to generate a prompt to the LLM.

As illustrated in FIG. 2, a template 220 may include references to one or more of knowledge base 230, function 240, plugins 250, and/or ontology 260. For example, a template 220 may include instructions to a language model, for example: (1) identifying a knowledge base 230 that the language model may search in fulfilling a user input (or that the language model is limited to searching in some implementations); (2) identifying functions 240 that may be utilized in fulfilling a user input; (3) identifying plugins 250 that may utilized in fulfilling a user input; and/or (4) identifying ontology data 260 that the language model may traverse in fulfilling a user input. A template 220 may also include instructions that are to be executed sequentially, such as that may be associated with different plugins 250. For example, a first instruction may be associated with a first plugin, and part (or all) of a response from the first plugin may be included in a second instruction to a second plugin.

In some implementations, a profile 210 may be associated with one or more specific language models that may be relevant in some way to the profile 210. For example, a profile 210 associated with the role of a life science analyst may be associated with BioGPT, a language model for biomedical text generation and mining.

In some implementations, a profile 210 and template 220 may be conceptually interchangeable. That is, an AIS may store one or more prompt templates, each containing references to one or more of knowledge base 230, function 240, plugins 250, and/or ontology 260, which may be used according to the context of an interaction.

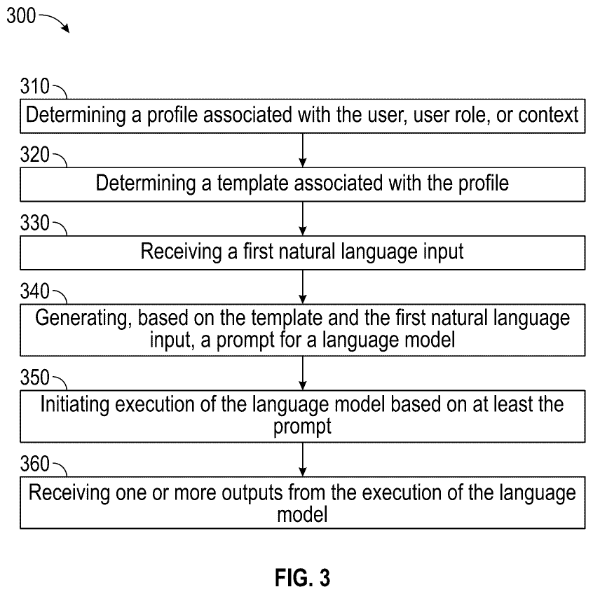

FIG. 3 is a flow diagram illustrating an example method 300 according to various embodiments. In some implementations, the method 300 may be performed in part or in full by an Artificial Intelligence system 102, including various modules within an Artificial Intelligence system 102. In various implementations, any one or all of the blocks may be performed by components of an AIS 102, as discussed herein, and/or any other suitable computing device or service, either alone or in combination with components of an AIS. The indicated flow of FIG. 3 is exemplary of only certain processes and is not meant to include all possible blocks.

At block 310, the AIS 102 determines a profile associated with a user, user role, or context. The determination may be performed by a profile selection module 106. In some embodiments, the user selects a profile from a drop-down list of available profiles and/or searches a list of profiles. In other embodiments, the AIS automatically selects a profile.

At block 320, the AIS 102 determines a template 220 associated with the profile. In certain implementations, this determination may be performed by a profile selection module 106 or a prompt generation module 108. As described above, the template 220 may comprise rules 225 and may include may include references to a knowledge base 230, functions 240, plugins 250, and/or ontology 260.

At block 330, the AIS 102 receives a first natural language input. The input may be received from a user via a user interface module 104, such as by typing the first natural language input into an interactive user control. The input may include a textual description provided by the user, whether by direct input from the user (e.g., typing a textual prompt or speaking the prompt for voice to text conversion) or using other input modalities to generate a user prompt (e.g., clicking on an automatically generated example user prompt of multiple example user prompts).

In some implementations, the AIS 102 may determine a profile and template associated with the profile, or update the determined profile and template, after receiving the first natural language input (or at any other time before block 340). For example, in some implementations, block 330 may be performed before blocks 310 and 320.

At block 340, the AIS 102 generates, based on the template and other inputs, such as the first natural user input, a prompt for a language model. The generation may be performed by a prompt generation module 108. In some implementations, a prompt generation module 108 may generate the prompt by, for example appending or replacing text in the template based on the first natural language user input and/or context.

In some implementations, generation of the prompt may include additional processing based on a knowledge base 230, functions 240, plugins 250, and/or ontology 260 associated with the profile. In some embodiments, the prompt generation module 108 may identify a subset of information within a knowledge base 230 (or summarize information in some way) that is relevant to the first natural language user input and/or context of the interaction, and append or replace text in the template based on the identified relevant information, thereby advantageously improving performance of the system and avoiding potential issues with a token limit in the prompt. For example, a knowledge base may contain voluminous documents, references, or records, only some of which are relevant to a user's request. Additionally, in some instances, a user may not have permission or authorization to access certain of the documents, references, or records in a knowledge base. In some embodiments, the prompt generation module 108 may identify a subset of the knowledge base (e.g., the top-N most relevant documents) and only refer to that subset in the prompt. For example, generating the prompt based on the template and the first natural language input may comprise: (1) accessing a knowledge base 230 associated with the profile (e.g., utilizing a plug-in); (2) identifying information within the knowledge base 230 that is relevant to the first natural language user input; and (3) appending or replacing text in the template to include the identified information (and/or some summarization of the identified information). Advantageously, by identifying a concrete knowledge base, the AI system can reduce problems such as “hallucinations” and inefficient processing.

Similarly, the system may identify relevant subsets of functions, plugins, and/or ontology associated with a profile and only refer to those subsets in the prompt.

At block 350, the AIS 102 initiates execution of the language model based on at least the prompt, such as by providing the prompt to the language model as a query. At block 360, the AIS 102 receives one or more outputs (a “response”) from the execution of the language model.

After receiving the response from the language model, the AIS may provide a result of the first natural language user input to a user, such as via a user interface module 104. In some implementations, the system may modify the result from the language model in generating a response to be displayed in a user interface. For example, if the output includes confidential information or information regarding restricted or unauthorized electronic data assets which the user does not have permission to access, the system may redact certain portions of the output before displaying the result.

### Example Feedback

In some implementations, the system may include mechanisms for providing feedback to a model after processing is complete. In some implementations, the feedback may indicate whether the output of the model's processing was a correct or acceptable result given the profile and the user input. The feedback may be generated manually by a user or automatically by the system. In some implementations, the feedback may be used to fine-tune the performance of the system. For example, the feedback may be used to modify a profile or profile template, or to modify a language model. For example, in some implementations, in response to receiving feedback from a user, the system may adjust or modify one or more weights associated with a profile or language model. In some implementations, the feedback may be used to further train or re-train a language model. For example, the system may prepare and provide some or all of the feedback as additional training data for a language model. Advantageously, utilizing feedback in such a manner can improve the performance of the system by, for example, allowing use of shorter prompts (e.g., reducing token count challenges) and lower-latency requests, while providing similar or even more relevant results.

### Example User Interfaces

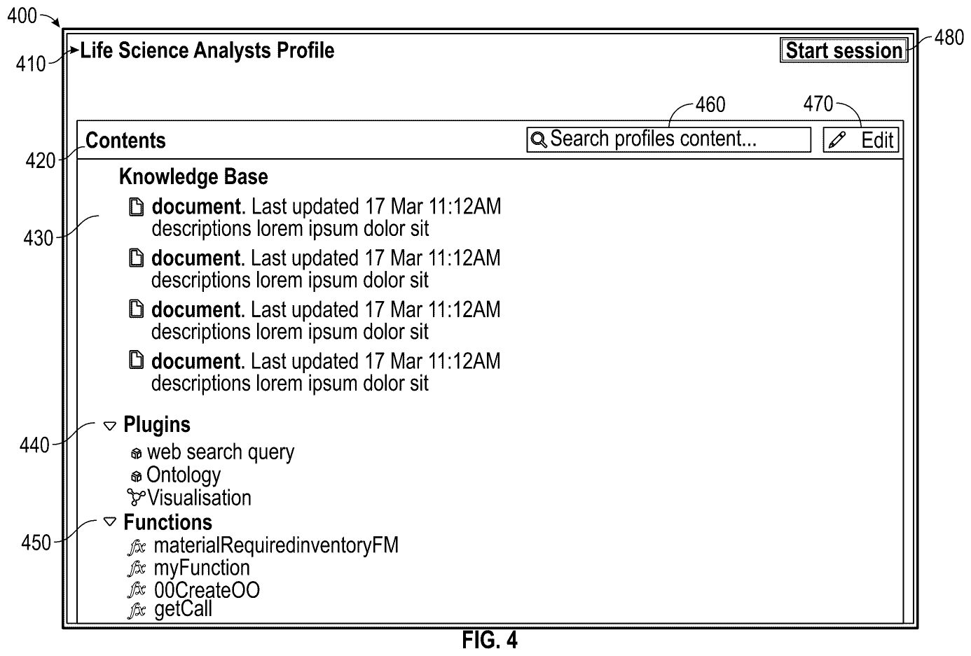

In some embodiments, the artificial intelligence system may include or provide for a graphical user interface for interacting with the artificial intelligence system, and allows for users to provide natural language inputs, and/or visualize and interact with responses or results. FIG. 4 illustrates an example user interface 400 showing contents of an example profile. In this example, the user interface 400 includes a profile title 410, “Contents” pane 420, and “Start Session” button 480. In this example, the profile title 410 is “Life Science Analysts,” indicating that the profile displayed by user interface 400 is associated with the user role of a “Life Science Analyst.”

The “Contents” pane 420 includes information regarding the contents of a profile 210, including a knowledge base section 430, plugins section 440, and functions section 450. The knowledge base section 430 includes information regarding the documents and/or other data that are relevant to fulfilling tasks associated with the particular profile. For example, knowledge base section 430 may include information regarding a document's title, last update time, and description. The plugins section 440 lists the plugins 250 associated with a profile 210. In this example, the “Life Science Analyst” profile contains a web search query plugin, an ontology plugin, and a visualization plugin. The functions section 450 lists the functions 240 associated with a profile 210. In some embodiments, the “Contents” pane 420 may include additional sections displaying information regarding a template 220 or ontology 260 associated with a profile 210. The “Contents” pane 420 further includes a search bar 460, which may enable a user to search the contents of a displayed profile, and an “Edit” button 470, which may enable a user to edit the contents of a displayed profile. The “Start session” button 480 may enable a user to start an AIS session using the displayed profile.

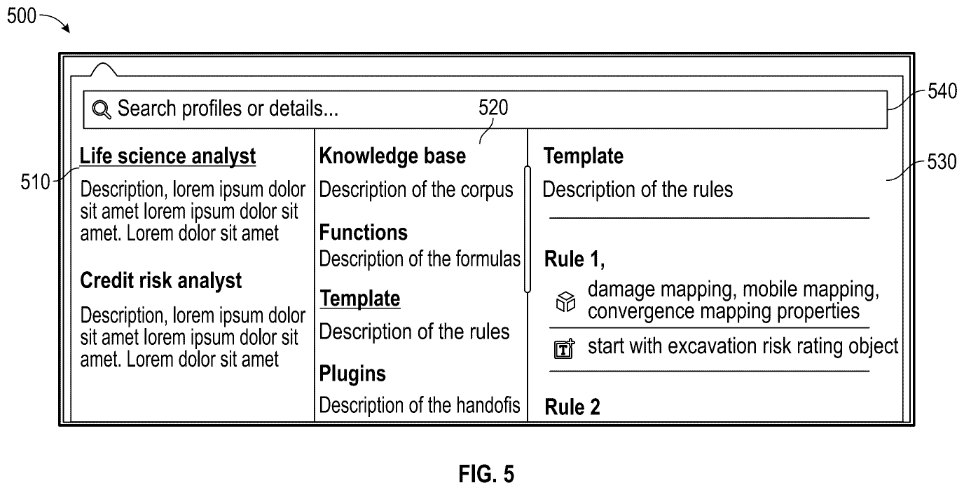

FIG. 5 illustrates another example user interface 500 showing the contents of an example profile. In this example, the user interface 500 includes a list of profiles 510, a list of content types 520, a details pane 530, and a search bar 540. The list of profiles 510 may list one or more profiles 210, along with a description of the one or more profiles 210. In this example, the list of profiles 510 includes two profiles 210, with the “Life Science Analyst” profile being selected.

The list of content types 520 may list the different types of content that may be associated with a selected profile from the list of profiles 510, such as a knowledge base 230, functions 240, template 220, and plugins 250, along with a description of the content associated with the selected profile. For example, the list 520 may include a description of the document corpus of a knowledge base 230 of the selected profile, a description of the formulas in functions 240 of the selected profile, a description of the rules 225 in a template 220 of the selected profile, and a description of tools (or “handoffs”) in plugins 250 of the selected profile. In this example, the “Template” content type is selected in the list of content types 520.

The details pane 530 may include details about the selected content type of the selected profile. In this example, the details pane 530 includes details about the template associated with the selected “Life Science Analyst” profile. The details pane 530 includes a brief description of the rules 225 in the template 220, and details about specific rules (Rule 1, Rule 2, etc.). The search bar 540 may enable a user to search for profiles or profile details.

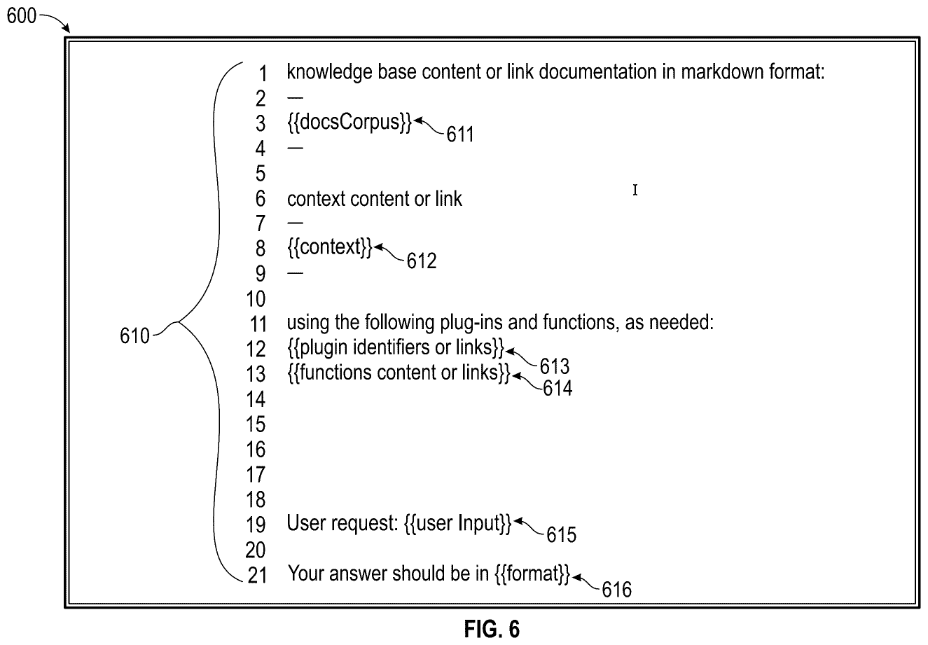

FIG. 6 illustrates an example user interface 600 showing an example excerpt 610 from an example profile template 220. As shown, the excerpt 610 may include both free-text and placeholders 611-616, which can be later modified or replaced based on the operational context of a particular user interaction, such as by a prompt generation module 108 while generating a language model prompt. For example, a prompt generation module 108 may replace the “docsCorpus” placeholder 611 with copies, indications or links to relevant data sources, such as documents from a knowledge base 230. A prompt generation module 108 may replace the “context” placeholder 612 with contextual information, such as prior conversations or user interactions. A prompt generation module 108 may replace the “plugin identifiers or links” placeholder 613 with indications or links to plugins 250 that a language model may utilize in processing the prompt. A prompt generation module 108 may replace the “functions content or links” placeholder 614 with indications or links to functions 240 that a language model may utilize in processing the prompt. A prompt generation module 108 may replace the “user input” placeholder 615 with a natural language input received from a user, such as via a user interface module 104. A prompt generation module 108 may replace the “format” placeholder 616 with indications or description of a particular format for an output of the language model, such as a particular format requested by the user.

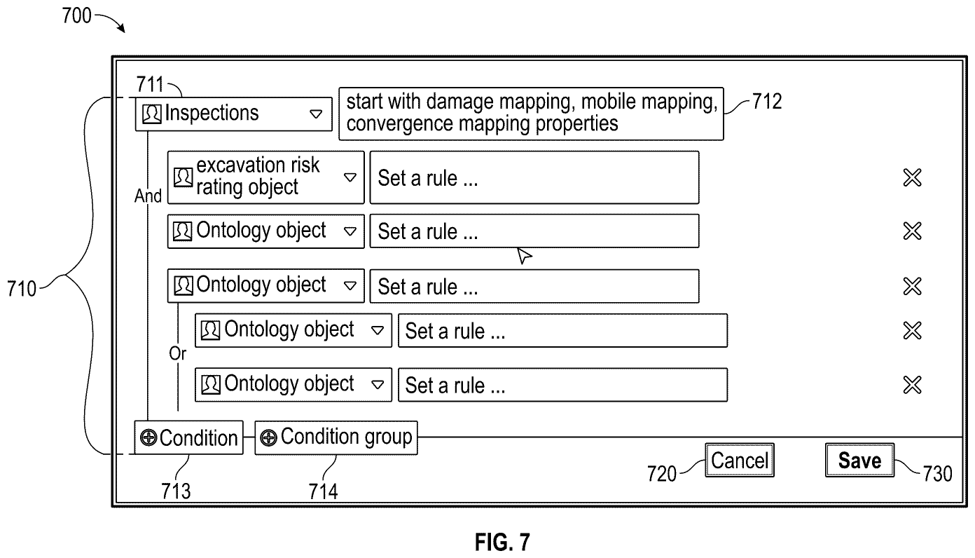

FIG. 7 illustrates an example user interface 700 for configuring or setting rules 225 associated with an example profile template 220. The user interface 700 includes an interactive user control 710, a “Cancel” button 720, and a “Save” button 730. The interactive user control 710 may enable a user to configure or set rules 225 associated with a profile template 220. As described above, in some implementations, rules 225 may be associated with particular data objects. Interactive user control 710 includes various fields enabling users to configure or set rules 225 that are associated with particular data objects. For example, in the example of FIG. 7, interactive user control 710 includes a dropdown field 711 allowing for selection of a particular data object and a text field 712 allowing for entry of a free-text or natural language rule associated with the selected data object. Interactive user control 710 further includes buttons 713 and 714, allowing a user to add conditions or condition groups to a rule or set of rules.

For example, as shown in FIG. 7, a user may wish to configure a set of rules to represent a procedure for analyzing a risk associated with an excavation (such as for a profile associated with a “Excavation Risk Analyst” user role) as follows:

### Step 1:

Start with damage mapping, mobile mapping, convergence mapping properties on object:inspections and object:metrics
Start with excavation risk rating object

### Step 2:

Calculate risk profile based on risk equations (this is a function registry)

### Step 3:

If <3: alert Geotech engineer and draw area of interest
If >3: evaluate sensor metric and show sensor specific reading.

Given the above procedure, a user may use interactive user control 710 to configure a set of rules associated with data objects to represent the steps of the procedure. As shown, the user may select the “Inspections” data object using dropdown field 711 and enter a free-text rule associated with the “Inspections” data object in text field 712. The user may then proceed to add conditions and condition groups using buttons 713 and 714 to configure rules representing the remaining steps of the procedure. After making the desired changes, the user may use the “Cancel” button 720 to discard the changes or the “Save” button 730 to save the changes. When the user saves changes using “Save” button 730, the system may modify a profile template to reflect the user's changes. For example, the system may convert the configured rule to free-text or a combination of free-text and placeholders (such as shown in FIG. 6).

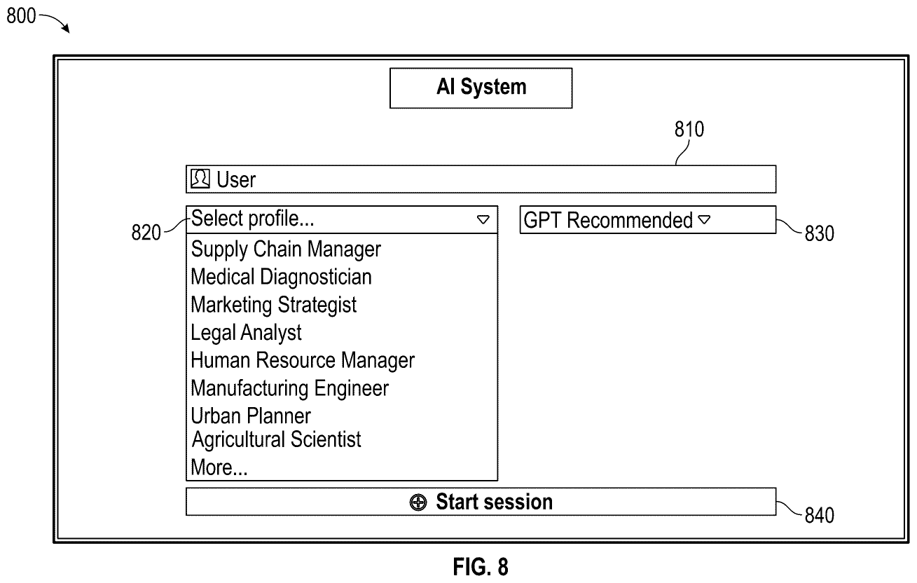

FIG. 8 illustrates an example user interface 800 for starting an AI system session. The user interface 800 includes a “User” field 810, a “Profile” field 820, a “Model” field 830, and a “Start Session” button 840. User interface 800 may enable a user to enter or select various session details prior to starting an AI system session. For example, the “User” field 810 may enable a user to select a particular user associated with an AI session, such as a “User” data object. In some embodiments, a particular “User” object may be pre-populated in “User” field 810 (e.g., the currently logged-in user). In some embodiments, a user may be required to provide further information or authentication (e.g., a password) before being allowed to select a particular user in the “User” field 810.

The “Profile” field 820 may enable a user to select a particular profile 210 associated with an AI session, such as a particular Profile data object. In some embodiments, and as shown in FIG. 8, the “Profile” field 820 may be a dropdown menu listing all selectable profiles. In some embodiments, the list of selectable profiles may only include profiles associated with a particular user, such as if a particular user is only authorized to select certain profiles. In some embodiments, the “Profile” field 820 may be pre-populated with a selected profile, such as based on the user.

The “Model” field 830 may enable a user to select a particular language model associated with an AI session. In some embodiments, and as shown in FIG. 8, the “Model” field may be pre-populated with a “recommended” model, such as a language model recommended based on a selected user or selected profile. In some embodiments, and as shown in FIG. 8, the “Model” field may be a dropdown menu listing all selectable models.

The “Start Session” button 840 may enable a user to start an AI session with a selected user, profile, and model.

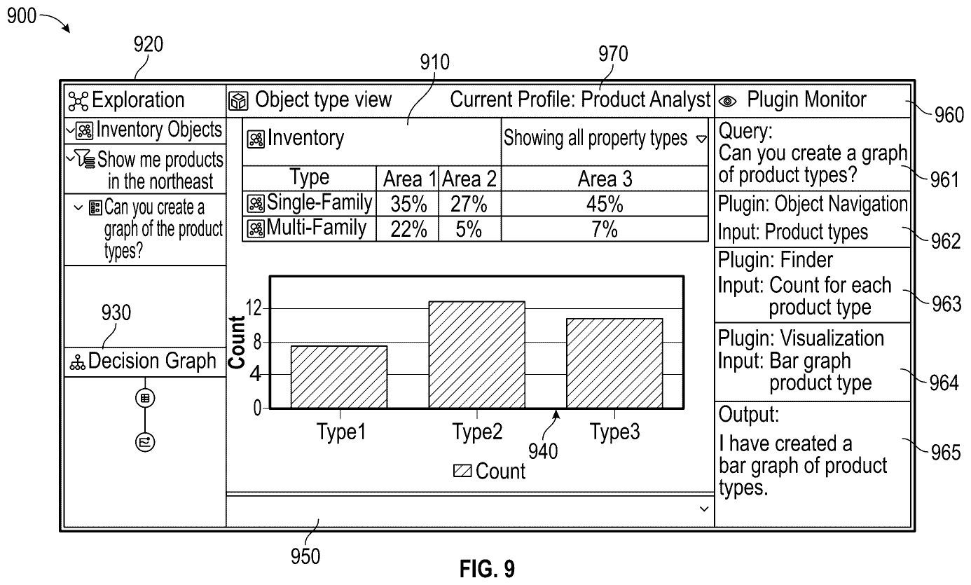

FIG. 9 illustrates an example user interface 900 according to various embodiments. The example user interface 900 includes an interaction pane 910, an exploration pane 920, decision graph 930, input area 950, and a plugins monitor pane 960. The user interface 900 may also display a name of a currently selected profile 970. The interaction pane 910 includes visualizations of data (such as bar graph 940) returned from multiple service that may be automatically selected and executed by the system in response to one or more user inputs provided in the input area 950. The exploration pane 920 includes a session history of user inputs, such as including natural language inputs and/or user selections made within the user interface 900. In the example of FIG. 9, the user interface 900 includes a decision graph 930 showing decisions the user took, e.g., different follow-up inputs, analyses, etc. that the user provided.

The user interface 900 includes a plugin monitor panel 960, which may comprise one or more graphical display elements (e.g., an icon or other visual indicator). According to various implementations, the plugin monitor panel 960 may indicate information about plugins 250 (or services) that have been performed by the system (or a language model in communication with the system), such as to indicate an input to a plugin and an output from a plugin. For example, graphical display element 962 may indicate that a language model has utilized an “Object Navigation” plugin and provided an input of “product types.” In various implementations, the plugin monitor panel 960 may dynamically update as specific plugins are utilized, thereby displaying in real-time tasks performed by a language model (and/or other components of the system).

In this example, the plugin monitor panel 960 includes graphical display elements 961, 962, 963, 964, and 965. Graphical display element 961 displays a user input previously provided in the input area 950. Graphical display elements 962, 963, and 964 display a name of a plugin and a corresponding input to said plugin. Graphical display element 965 displays an output from a language model.

### Additional Implementation Details and Embodiments

Various embodiments of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

Some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments.

### Example Clauses

Examples of implementations of the present disclosure can be described in view of the following example clauses. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.

Clause 1. A computer-implemented method comprising, by one or more hardware processors executing program instructions: receiving, from a user, a first natural language user input; determining a profile associated with the user, user role, or context, the profile including indications of: one or more knowledge base; one or more functions; one or more templates; and one or more plugins; generating, based on at least the first natural language user input and the determined profile, a prompt for a language model; and providing the prompt to the language model.

Clause 2. The computer-implemented method of Clause 1, wherein the one or more knowledge base comprises a searchable corpus of data.

Clause 3. The computer-implemented method of Clause 1, wherein the one or more functions comprise one or more formulas usable to calculate and/or derive properties.

Clause 4. The computer-implemented method of Clause 1, wherein the one or more templates comprise one or more rules of business logic.

Clause 5. The computer-implemented method of Clause 4, wherein the one or more rules are defined in natural language.

Clause 6. The computer-implemented method of Clause 4, wherein at least one of the one or more rules is associated with a data object.

Clause 7. The computer-implemented method of Clause 1, wherein the one or more plugins comprise one or more data processing tools.

Clause 8. The computer-implemented method of Clause 1, wherein at least one of the plugins is activated prior to providing the prompt to the language model and is configured to provide a plugin output that is at least partially included in the prompt.

Clause 9. The computer-implemented method of Clause 1, further comprising: receiving an output from the language model, responsive to the natural language user input.

Clause 10. The computer-implemented method of Clause 9, wherein at least one of the plugins is activated after receiving the output and is configured to generate, based on at least a portion of the output, at least a portion of a result provided to the user.

Clause 11. The computer-implemented method of Clause 1, wherein at least one of the plugins is configured to access an object database comprising a plurality of objects stored according to an object ontology.

Clause 12. The computer-implemented method of Clause 11, wherein the at least one of the plugins is configured to search the object database for an object associated with at least a portion of an output provided by the language model.

Clause 13. The computer-implemented method of Clause 11, wherein the at least one of the plugins is configured to search the object database for an object associated with at least a portion of the natural language user input.

Clause 14. The computer-implemented method of Clause 1, wherein the language model is selected based on the determined profile.

Clause 15. The computer-implemented method of Clause 1, wherein the one or more plugins are automatically selected according to one or more rules associated with the one or more templates associated with the profile.

Clause 16. The computer-implemented method of Clause 1, wherein the profile further comprises ontology data, wherein the ontology data comprises a semantic knowledge graph of data objects.

Clause 17. The computer-implemented method of Clause 1, wherein generating the prompt comprises: determining, receiving, or accessing a template associated with the profile; and generating the prompt based on at least the first natural language user input and the template.

Clause 18. The computer-implemented method of Clause 17, wherein generating the prompt based on at least the first natural language user input and the template further comprises: appending or replacing text in the template based on the first natural language input.

Clause 19. The computer-implemented method of Clause 18, wherein generating the prompt based on at least the first natural language input and the template further comprises: accessing a first knowledge base of the one or more knowledge bases associated with the profile; identifying information within the first knowledge base relevant to the first natural language user input; and appending or replacing text in the template based on the identified information.

Clause 20. The computer-implemented method of Clause 1, wherein said determining the profile comprises: receiving user input identifying the profile.

Clause 21. The computer-implemented method of Clause 20, wherein the user input is received via a drop-down menu listing one or more profiles.

Clause 22. The computer-implemented method of Clause 1, wherein said determining the profile comprises: selecting a profile based on context associated with the user.

Clause 23. The computer-implemented method of Clause 1, wherein the context comprises a profile used in a last user session by the user.

Clause 24. The computer-implemented method of Clause 1, wherein the profile is associated with the language model.

Clause 25. The computer-implemented method of Clause 1, wherein the language module is trained based on training data particularly relevant to the profile.

Clause 26. The computer-implemented method of Clause 1, further comprising initiating execution of the language model based on at least the prompt.

Clause 27. The computer-implemented method of Clause 26, further comprising determining, receiving, or accessing one or more outputs from the execution of the language model.

Clause 28. The computer-implemented method of Clause 27, further comprising: receiving user input indicative of relevance of the one or more outputs and the first natural language user input; and initiating updates to one or more weights associated with the language model based on the feedback.

Clause 29. The computer-implemented method of Clause 28, wherein the language model is specific to a use case associated with the profile.

Clause 30. The computer-implemented method of Clause 28, wherein the feedback comprises whether at least one of the one or more outputs was an acceptable output.

Clause 31. The computer-implemented method of Clause 28, further comprising: generating, based on the one or more outputs, a result; and displaying an indication of the result in a user interface.

Clause 32. The computer-implemented method of Clause 31, wherein generating the result further comprises modifying the output from the language model based on one or more permissions associated with a user.

Clause 33. The computer-implemented method of Clause 31, wherein the profile is associated with a user role and the user role comprises one of: Supply Chain Manager, Medical Diagnostician, Marketing Strategist, Legal Analyst, Human Resource Manager, Manufacturing Engineer, Urban Planner, Agricultural Scientist, Life Sciences Analyst, or Credit Risk Analyst.

Clause 34. A system comprising: a computer readable storage medium having program instructions embodied therewith; and one or more processors configured to execute the program instructions to cause the system to perform the computer-implemented method of any of Clauses 1-33.

Clause 35. A computer program product comprising a computer-readable storage medium having program instructions embodied therewith, the program instructions executable by one or more processors to cause the one or more processors to perform the computer-implemented method of any of Clauses 1-33.

Clause 36. A computing system comprising: a user interface module configured to receive a user input from a user computing device; a context module configured to store context comprising information associated with one or more of a user or user session; a profile selection module configured to select a first profile of a plurality of profiles based at least on a role or subject matter area associated with the context, wherein the first profile includes a natural language description associated with the role or subject matter area that is configured to be included in a prompt to a language model to guide the language model in develop a more relevant response; and a prompt generation module configured to generate a prompt for the language model based at least on the user input from the user interface module, the context from the context module, and the first profile selected by the profile selection module to; wherein the computing system is configured to transmit the prompt to the language model.

What is claimed is:

1. A computer-implemented method comprising, by one or more hardware processors executing program instructions:
receiving, from a user, a first natural language user input;
determining a profile associated with the user, user role, or context, the profile including indications of:
one or more knowledge base;
one or more functions;
one or more templates; and
one or more plugins;
generating, based on at least the first natural language user input and the determined profile, a prompt for a language model; and
providing the prompt to the language model.

2. The computer-implemented method of claim 1, wherein the one or more knowledge base comprises a searchable corpus of data.

3. The computer-implemented method of claim 1, wherein the one or more functions comprise one or more formulas usable to calculate and/or derive properties.

4. The computer-implemented method of claim 1, wherein the one or more templates comprise one or more rules of business logic.

5. The computer-implemented method of claim 4, wherein the one or more rules are defined in natural language.

6. The computer-implemented method of claim 4, wherein at least one of the one or more rules is associated with a data object.

7. The computer-implemented method of claim 1, wherein the one or more plugins comprise one or more data processing tools.

8. The computer-implemented method of claim 1, wherein at least one of the plugins is activated prior to providing the prompt to the language model and is configured to provide a plugin output that is at least partially included in the prompt.

9. The computer-implemented method of claim 1, further comprising:
receiving an output from the language model, responsive to the natural language user input.

10. The computer-implemented method of claim 9, wherein at least one of the plugins is activated after receiving the output and is configured to generate, based on at least a portion of the output, at least a portion of a result provided to the user.

11. The computer-implemented method of claim 1, wherein at least one of the plugins is configured to access an object database comprising a plurality of objects stored according to an object ontology.

12. The computer-implemented method of claim 11, wherein the at least one of the plugins is configured to search the object database for an object associated with at least a portion of an output provided by the language model.

13. The computer-implemented method of claim 11, wherein the at least one of the plugins is configured to search the object database for an object associated with at least a portion of the natural language user input.

14. The computer-implemented method of claim 1, wherein the language model is selected based on the determined profile.

15. The computer-implemented method of claim 1, wherein the one or more plugins are automatically selected according to one or more rules associated with the one or more templates associated with the profile.

16. The computer-implemented method of claim 1, wherein the profile further comprises ontology data, wherein the ontology data comprises a semantic knowledge graph of data objects.

17. The computer-implemented method of claim 1, wherein generating the prompt comprises:
determining, receiving, or accessing a template associated with the profile; and
generating the prompt based on at least the first natural language user input and the template.

18. The computer-implemented method of claim 17, wherein generating the prompt based on at least the first natural language user input and the template further comprises:
appending or replacing text in the template based on the first natural language input.

19. The computer-implemented method of claim 18, wherein generating the prompt based on at least the first natural language input and the template further comprises:
accessing a first knowledge base of the one or more knowledge bases associated with the profile;
identifying information within the first knowledge base relevant to the first natural language user input; and
appending or replacing text in the template based on the identified information.

20. The computer-implemented method of claim 1, wherein said determining the profile comprises:
receiving user input identifying the profile.
